(19) United States
(12) Patent Application Publication
(10) Pub. No.: US 2026/0235214 A1
(43) Pub. Date: Aug. 13, 2026

(54) Multi-Way Valve for Refrigerators

(71) Applicant: EMICOL Eletro Eletrônica S.A., Itu (BR)

(72) Inventor: Fábio Fortunato Christiano, Itapira (BR)

(21) Appl. No.: 19/538,260

(22) Filed: Feb. 12, 2026

(30) Foreign Application Priority Data
Feb. 13, 2025 (BR) 202025002850-1

(51) Int. Cl. F16K 11/22; F16K 11/24; F25B 41/20

(52) U.S. Cl. CPC F16K 11/22; F16K 11/24; F25B 41/20

(57) ABSTRACT

A multi-way valve includes a valve body that defines a longitudinal inner duct fed from an inlet located at one end of the inner duct, in addition to at least one outlet, each of said outlets being controlled in opening by a respective coil and each coil and outlet assembly being arranged transversely in relation to the longitudinal dimension of the valve body. In said valve the inlet and outlet covers and the coils are fixed to the valve body by means of a mechanical engagement.

### CROSS-REFERENCE TO RELATED APPLICATION

This application claims priority to Brazilian Patent Application No. 202025002850-1 filed Feb. 13, 2025, the disclosure of which is hereby incorporated by reference in its entirety.

### BACKGROUND

### Field

The present invention refers to a multi-way valve configuration for flow control, particularly for refrigerators and similar equipment.

### Description of Related Art

Multi-way valves are widely known in the art and are defined as comprising at least one inlet port and at least one outlet port, the one or more outlet ports being linked to respective control coils for the selective and individualized opening and closing of each of the at least one outlet.

To this end, said valves have a monolithic body from which at least one water inlet projects longitudinally, which feeds an internal longitudinal and approximately cylindrical duct. Transversely to said internal duct, one or more water outlets are provided, for example, intended for a chilled water dispenser (usually located on the refrigerator door), an external ice dispenser (also usually located on the refrigerator door) and a water feeder for ice production inside the freezer.

Each of these possible water outlets is aligned with a corresponding coil which, upon an electrical command (energization), opens the respective valve outlet allowing a flow of water from the inlet/internal duct to the respective outlet. To this end, and in a known manner, the energization of the coil winding generates an electromagnetic field which displaces a ferromagnetic actuator from a rest position (in this case the closing of the outlet valve) defined by a spring, or similar elastic element, to an active position, or opening of the valve, with displacement of the ferromagnetic actuator against the action of said spring.

Document U.S. Pat. No. 11,067,184 teaches a valve body comprising one inlet and three outlets, each of the outlets being controlled by a corresponding coil responsible for opening or closing the valve depending on the energization condition of the coil. Due to the electrical connectors for powering each coil, the aforementioned document instructs to place the outermost coils in the foreground, while the central coil is placed on a higher plane relative to the outermost coils. In this way, the connection terminals of the central coil do not spatially interfere with the volume occupied by any of the outermost coils.

The valve body is an engineering component with a certain degree of complexity and dimensional precision, as it must be produced, usually injection molded, in a way that withstands thermal conditions, supports the working pressures of the water, which vary depending on the refrigerator owner's installations, prevents leaks, and other operational conditions. Furthermore, due to the design and manufacturing costs, it is imperative that the valve body be supplied to, and used by, various manufacturers of white goods (major household appliances) in order to amortize these costs. Therefore, considering that each manufacturer uses its own standards (dimensions, type of fittings and hoses, etc.), it is imperative that any valve body be adaptable to these particularities. To this end, and usually, either of the inlet or outlet terminals receives a so-called “cap,” which must be securely fixed to the valve body and, at the opposite end, be able to accommodate a hose fitting according to the appliance manufacturer's standards.

In order to allow for a “standardizable”, and even more watertight, coupling, these covers are usually welded to the valve body. However, this solution is not without drawbacks. Firstly, the high investment in plastic welding equipment must be considered, whether it is of the thermal welding or laser welding type. In addition, it is not uncommon to find plastic burrs resulting from the welding process, which can clog the valve. Finally, welding may not guarantee a watertight joint between the valve body and the cover, as well as between the body and the cover; in this particular case, the burr resulting from the welding can cause leakage between the pin cover and the membrane guide.

Thus, the need for a multi-way valve capable of overcoming the drawbacks of the art remains. In particular, an objective of the present model is a multi-way valve for refrigerators in which the valve covers and caps are mechanically fixed to the valve body.

Another objective of the invention is a multi-way valve for refrigerators equipped with interchangeable valve caps and/or covers, the caps and covers having appropriate dimensions adapted to the respective refrigerator models.

### SUMMARY OF THE INVENTION

This and other objectives are achieved from a multi-way valve for refrigerators, comprising a valve body that defines a longitudinal inner duct and fed from an inlet disposed at one end of the inner duct, in addition to at least one outlet, each of said outlets being controlled in opening by a respective coil and each coil and outlet assembly being arranged transversely in relation to the longitudinal dimension of the valve body, said valve being defined by the inlet and outlet covers and the coils being fixed to the valve body by means of mechanical engagement.

In one embodiment, the mechanical engagement of the coils is a threaded engagement between the external thread of the cylindrical base of the cover in relation to the internal counter thread of the coil seat.

In one embodiment, the membrane comprises a membrane disc, which is disposed and held in position between the cylindrical base of the cover and the coil seat and which seals the coil seat in relation to the cylindrical base of the cover.

In one embodiment, the mechanical coupling of the hoses at the inlet and outlets is a clip-on coupling. In particular, the clip has a cylindrical structure with a lateral surface defined by handles projecting from a base disc with a central opening, the central opening being able to receive a fixing sleeve arranged and fixed to the hose.

In one embodiment, the handles engage respective triangular profile teeth provided on the outer surface of the inlet ring of the intermediate connector, the intermediate connector being fixed to the valve inlet nozzle by means of a thread. Furthermore, the handles engage respective triangular profile teeth provided on the outer surface of the valve outlet nozzle.

This and other objectives are achieved using a multi-way valve for refrigerators, comprising a valve body that defines a longitudinal inner duct and is fed from an inlet located at one end of the inner duct, in addition to three outlets, each of said outlets being controlled in opening by a respective coil and each coil and outlet assembly being arranged transversely in relation to the longitudinal dimension of the valve body; and the central coil being coplanar in relation to the extreme coils and being arranged at 90° in relation to the position of the extreme coils, and the electrical supply terminals, as well as the respective female connectors of the extreme coil harness, being parallel in relation to the longitudinal axis of the valve, while the electrical supply terminals of the central coil and the respective female connectors that couple them are perpendicular in relation to the horizontal plane defined by the female connectors.

### BRIEF DESCRIPTION OF THE DRAWINGS

The terms Fig., Figs., Figure, and Figures are used interchangeably in the specification to refer to the corresponding figures in the drawings.

The object of the present solution can be better understood from the detailed description that follows, in a preferred and non-limiting embodiment, which is made with the support of the attached figures, presented for illustrative and non-limiting purposes, in which:

FIG. 1 is a perspective view of a valve, according to the present solution;

FIG. 2 is a perspective view of an alternative valve, according to the present solution;

FIG. 3′ is a cross-sectional view of the valve inlet cover;

FIG. 3″ is a cross-sectional view of the valve outlet covers;

FIG. 4 is a perspective view with the inlet and outlet covers exploded;

FIG. 5 is a perspective view illustrating two covers, with and without their respective coils; and

FIG. 6 is an exploded cross-sectional view of a coil.

### DESCRIPTION

In accordance with the figures listed above, 1, as a whole, indicates a multi-way valve, or multi-way solenoid valve. Said valve 1 comprises a valve body 2 that defines, internally, a longitudinal and approximately cylindrical internal duct (not visible). In a non-limiting manner, valve 1 comprises an inlet 4 disposed at a longitudinal end of the internal duct and in fluid communication with it, in addition to outlets 5A, 5B and 5C as illustrated in the embodiment shown in the figures.

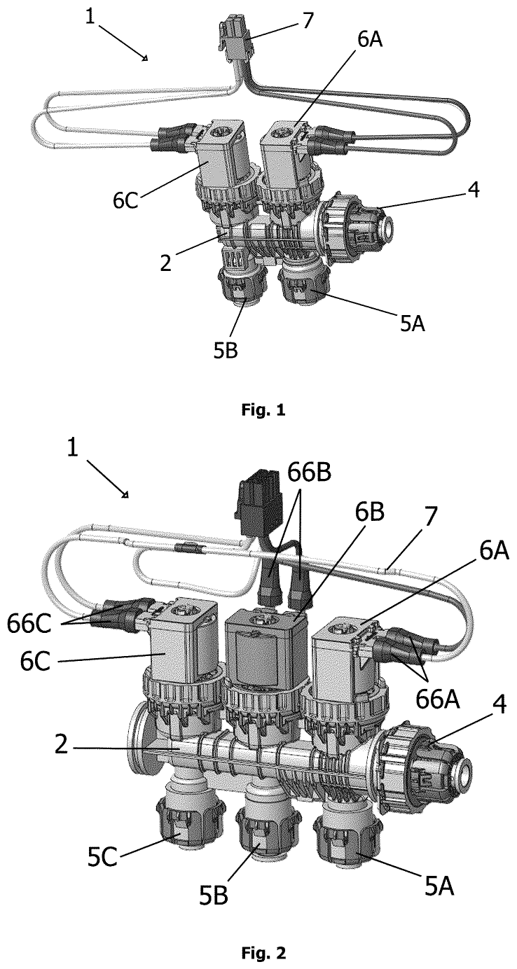

In a first transverse to the longitudinal axis of valve 1, a coil 6A is provided aligned with output 5A, in a second transverse a coil 6B aligned with output 5B as shown in FIG. 1, as well as a coil 6C aligned with output 5C in a third transverse, as shown in FIG. 2. As is clear to experts in the sector, a solenoid valve 1 is not limited or defined by the number of inputs or outputs, such parameters being defined according to the specific application of valve 1.

Each of the coils 6A, 6B or 6C is electrically connected to respective conductor wires of an electrical power harness 7. Thus, when any of the coils is energized, the electromagnetic field generated by the respective winding 8 displaces the ferromagnetic actuator 9, which moves inside the cover 10, or coil cover, against the action of the spring 11, displacing the membrane 22 and thus opening the valve and releasing the flow of water through the respective outlet, in a manner known in the art.

In accordance with the present solution, the inlet and outlet covers of valve 1, as well as coils 6A, 6B and 6C, are fixed to the valve body 2 by means of a mechanical coupling.

More specifically, each of the coils 6A, 6B or 6C comprises a cover 10, or lid, defined by a cylindrical base 12, externally provided with a thread 13 from the center of which projects a hollow cylindrical body 14, inside which the ferromagnetic actuator 9 moves axially as a function of the opposing forces, which are generated by the winding 8 and the spring 11. A coil body 16, inside which the winding 8 is arranged and from which the electrical power supply terminals 15 of the winding 8 project, has a central cylindrical opening 17, suitable for fitting into the cylindrical body 14. Preferably, the coil body 16 is a polymeric structure over-injected onto the winding 8 and partially onto the terminals 15.

In order to keep the coil body 16 in position, after being fitted onto the cylindrical body 14, said cylindrical body has external ridges 19 and upper teeth 18, thus blocking any movement of the coil body 16 in rotation or in the axial direction, respectively. Although not visible in the figures, the central cylindrical opening 17 of the coil body 16 has respective grooves distributed in positions cooperating with the ridges 19. The upper teeth 18, when at rest, define an external diameter larger than the internal diameter of the central opening 19 of the coil body 16. In this way, the upper teeth 18 penetrate the interior of the central opening 17 in a retracted manner, and expand in the radial direction after traversing the entire length of the central opening 17.

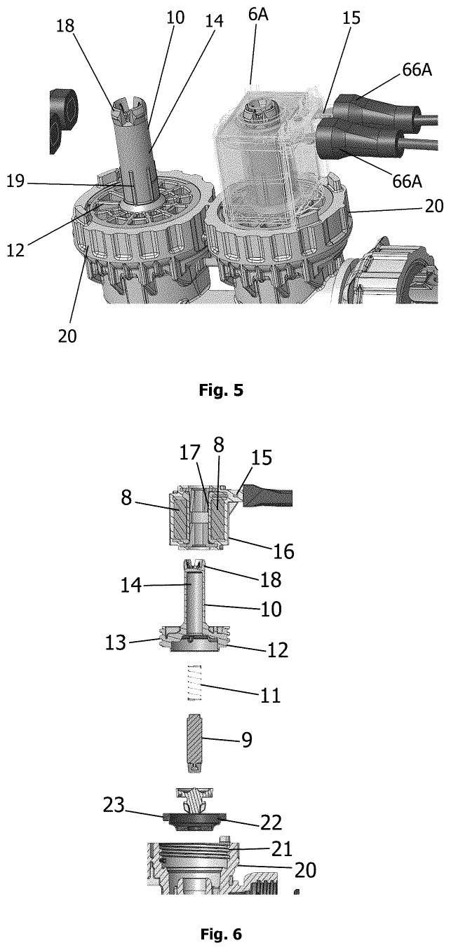

Furthermore, and with particular attention to the embodiment illustrated in FIG. 2, the outermost coils 6A and 6C are coupled to the valve body 2 so that the respective power supply terminals 15 (see FIG. 5), as well as the respective female connectors 66A and 66C of the harness 7, remain parallel to the longitudinal axis of the valve 1. On the other hand, the central coil 6B, coplanar with respect to the outermost coils 6A and 6C, is positioned at 90° with respect to the position of the outermost coils 6A and 6C, while its respective power supply terminals (not visible) and the respective female connectors 66B that couple them, remain perpendicular to the horizontal plane defined by the female connectors 66A and 66C.

Finally, and as mentioned, the cover 10 is fixed to the valve body 2 by means of mechanical engagement and, in particular, by threading. For this purpose, from the valve body 2 projects, in a direction transverse to the longitudinal axis of the valve 1 (the longitudinal axis being coincident with the axial axis of the coil), a cylindrical coil seat 20 internally provided with a counter thread 21 of the thread 13. In addition, said membrane 22, in a single and malleable body, comprises a membrane disc 23 capable of being fixed in position by the cylindrical base 12 after it is screwed into the interior of the coil seat 20 of the valve body 2. In this way, the membrane disc 23 supports the membrane 22 in position as well as acts as a seal between the coil seat 20 and the cylindrical base 12 of the cover 10.

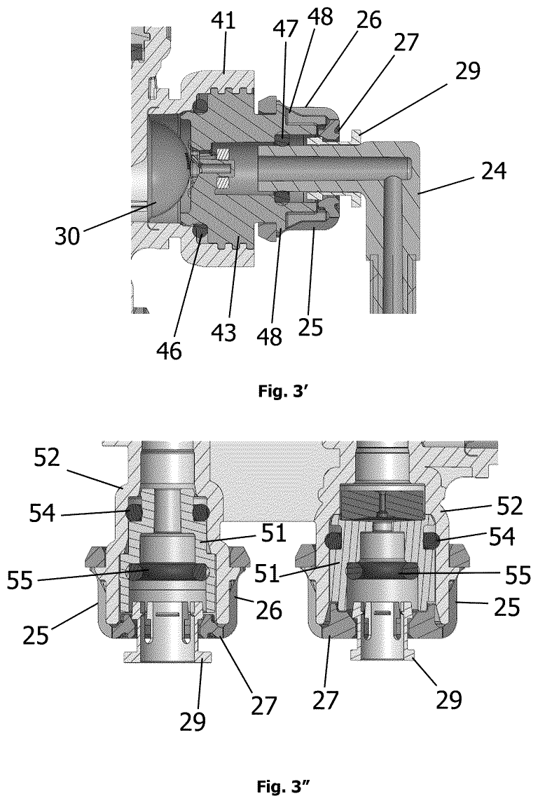

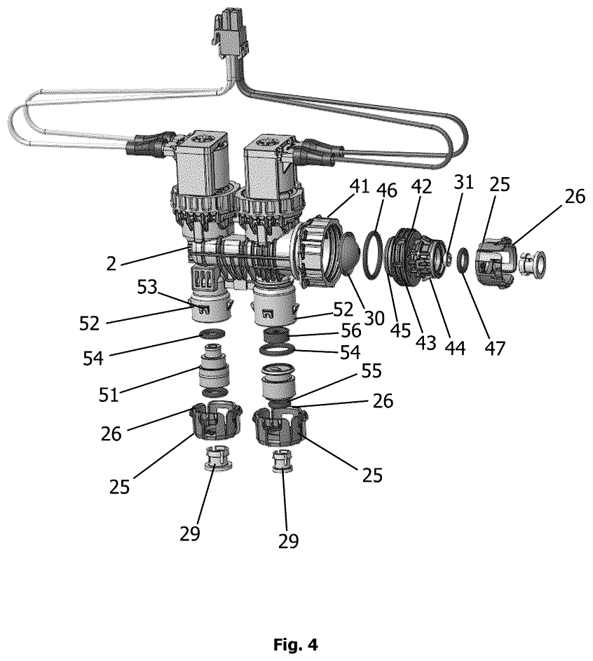

As for at least one inlet 4 and at least one outlet 5A, to which respective hoses 24 are connected (see in particular FIG. 3′), each of these connections is obtained from a clamp 25, which is fixed to the valve body 2 by a clip, and in cooperation with a fixing sleeve 29.

As illustrated in FIG. 3′, 3″ and 4, said clamp 25 is a cylindrical structure whose lateral surface is defined by handles 26, preferably by four handles 26, which project from a base disc 27 provided with a central opening 28. Said central opening is thus able to receive a fixing sleeve 29 disposed and fixed to the hose 24, as well as retaining the hose and the fixing sleeve by mechanical interference. In turn, each of the handles 26 is able to engage with respective teeth, thus keeping any of the hoses 24 properly coupled to the valve 1, through a safe and agile quick-release coupling system.

More in particular, the inlet 4 of the valve 1 is defined by a nozzle 41 internally equipped with a thread, in which an intermediate connector 42 is fixed by means of its external thread. The intermediate connector 42 is a basically cylindrical structure comprising a central ring 43, of larger diameter, interposed between an inlet ring 44 and an outlet ring 45. The inlet ring 44 is able to externally receive and fix the clip 25 by means of respective teeth 48 of triangular profile, in angular correspondence with the handles 26 of the clip 25. The opposite end of the intermediate connector 42 comprises a circular edge able to retain a metal filter 30 inside the inlet nozzle 41.

As mentioned, the intermediate connector 42 is equipped with an external thread for coupling inside the nozzle 41. For this purpose, said thread is formed on the external surface of the central ring 43. In an internal position of the central ring 43, a pressure regulator 31 is inserted and fixed, if necessary. Furthermore, for the watertight coupling of the intermediate connector 42 inside the nozzle 41, an O-ring 46 is also provided, while the watertight connection between the hose 24 and the inner surface of the inlet ring 44 is ensured by the O-ring 47.

Finally, and with regard to the coupling of hoses (not illustrated, but similar in construction to hose 24) in any of the outlets 5A, 5B or 5C of the valve body 2, the illustrated construction is basically similar to that described above in relation to the coupling of hose 24 in the inlet 4, but with the intermediate connector 42 being replaced by a sleeve 51.

More specifically, any of the outlets 5A, 5B or 5C is defined by a cylindrical stepped nozzle 52, with progressively larger diameter in the downstream direction (relative to the water flow). Internally, the nozzle 52 defines an equally cylindrical cavity in steps which is suitable to receive a sleeve 51 with an external surface of corresponding shape. Externally, the nozzle 52 comprises respective teeth 53 of triangular profile, in angular correspondence with the handles 26 of the clamp 25.

Similarly to inlet 4, each of the nozzles 52 receives a first O-ring 54 to ensure a seal between the sleeve 51 and the nozzle 52, while the tight connection between a hose and the sleeve 51 is ensured by the O-ring 55. Alternatively, and particularly with regard to outlet 5A, a flow regulator 56 may also be provided. In the illustrated embodiment, outlet 5A is intended for connecting a ¼″ hose, while outlet 5B is intended for connecting a 5/16″ hose. Notwithstanding the illustrated arrangement, the diameter of the hoses to be connected to each of the outlets 5A, 5B or 5C may be altered according to the characteristics of the refrigerator, or appliance, in which valve 1 is used.

In this way, the mechanical couplings for the hoses and the arrangement of the coils for configurations with L or more coils achieve the above-established objectives, and overcome the problems with the valves of the art.

1. A multi-way valve for refrigerators, comprising a valve body that defines a longitudinal inner duct and fed from an inlet disposed at one end of the inner duct, in addition to at least one outlet, each of said outlets being controlled in opening by a respective coil and each coil and outlet assembly being arranged transversely in relation to the longitudinal dimension of the valve body, wherein the inlet and outlet covers and the coils are fixed to the valve body by means of mechanical engagement.

2. A multi-way valve, according to claim 1, wherein the mechanical engagement of the coils is a threaded engagement between the external thread of the cylindrical base of the cover in relation to the internal counter thread of the coil seat.

3. A multi-way valve, according to claim 1, wherein the membrane comprises a membrane disc, which is disposed and held in position between the cylindrical base of the cover and the coil seat and which seals the coil seat in relation to the cylindrical base of the cover.

4. A multi-way valve, according to claim 1, wherein the mechanical coupling of the hoses at the inlet and at the outlets is a coupling by means of a clamp.

5. A multi-way valve, according to claim 1, wherein the clamp has a cylindrical structure with a lateral surface defined by handles that project from a base disc provided with a central opening, and the central opening being able to receive a fixing sleeve disposed and fixed to the hose.

6. A multi-way valve, according to claim 5, wherein the handles engage respective teeth of triangular profile provided on the outer surface of the inlet ring of the intermediate connector, and the intermediate connector is fixed to the nozzle of the valve inlet by means of a thread.

7. A multi-way valve, according to claim 5, wherein the handles engage respective teeth of triangular profile provided on the outer surface of the nozzle of the valve outlets.

8. A Multi-way valve for refrigerators, comprising a valve body that defines a longitudinal inner duct and is fed from an inlet located at one end of the inner duct, in addition to three outlets, each of said outlets being controlled in opening by a respective coil and each coil and outlet assembly being arranged transversely in relation to the longitudinal dimension of the valve body, wherein the central coil is coplanar in relation to the extreme coils and is arranged at 90° in relation to the position of the extreme coils, and the electrical supply terminals, as well as the respective female connectors of the harness of the extreme coils are parallel in relation to the longitudinal axis of the valve, while the electrical power supply terminals of the central coil and the respective female connectors that couple them, remain perpendicular to the horizontal plane defined by the female connectors.
